(19) United States
(12) Patent Application Publication
(10) Pub. No.: US 2026/0361254 A1
(43) Pub. Date: Nov. 12, 2026

(54) System and Method to Mitigate Regenerative Energy from Backspin of Permanent Magnet Motor for Progressive Cavity Pump

(71) Applicant: Weatherford Technology Holdings, LLC, Houston, TX (US)

(72) Inventors: Mohammed S. Arefeen, Houston, TX (US); Ramakrishna Prabhu Ranganathan, Houston, TX (US); Marwan Al Bayati, Houston, TX (US)

(21) Appl. No.: 19/211,561

(22) Filed: May 19, 2025

Related U.S. Application Data
(60) Provisional application No. 63/801,481, filed on May 7, 2025.

(51) Int. Cl. H02P 29/024; E21B 43/12; H02P 3/22; F04C 2/107; F04C 13/00; F04C 15/00

(52) U.S. Cl. CPC H02P 29/025; E21B 43/126; H02P 3/22; F04C 2/1071; F04C 13/008; F04C 15/008; H02P 2207/05

(57) ABSTRACT

A variable speed drive is connected to an alternating (AC) power source and drive a permanent magnet motor for a progressive cavity pump. To drive the permanent magnet motor, an input converter converts AC power from the AC power source to DC power for a DC bus, and an output inverter converts the DC power on the DC bus to AC power for output to the permanent magnet motor. A detector can detect a power outage associated with the AC power, and a contactor is closed in response to the power outage detected. With the contactor closed, a resistor is electrically connected across the lines of the DC bus to dissipate any generated energy caused by backspin of the permanent magnet motor.

### CROSS-REFERENCE TO RELATED APPLICATIONS

This application claims the benefit of U.S. Provisional Appl. No. 63/801,481 filed May 7, 2025, which is incorporated herein by reference in its entirety.

### BACKGROUND OF THE DISCLOSURE

Progressive cavity pump (PCP) systems are used for artificial oil lifting operations on wellheads. The PCP systems have a drive at the surface and have a rotor and stator downhole. The drive rotates a rod string that turns the rotor in the stator. This lifts a fluid column up a tubing string to be produced at the surface.

For example, FIG. 1 illustrates a progressive cavity pump system 10 according to the state of the art. The progressing cavity pump system 10 has a surface drive 14, a rod string 16, and a downhole progressive cavity pump 30. The surface drive 14 has an electric motor 20 receiving power from a utility AC power source 12. A pulley/belt or gearbox assembly 22 connect the electric motor 20 to a drive head 24 mounted above the wellhead 15. The drive head 24 typically includes a stuffing box to seal the connection of the drive head 24 to the rod string 16. A clamp 23 and a polished rod 25 are used to transmit the rotation from the drive head 24 to the rod string 16.

Downhole, the progressive cavity pump 30 installs below the wellhead 15 at a substantial depth (e.g., about 2000 m) in the wellbore. Typically, the progressive cavity pump 30 has a single helical-shaped rotor 32 that turns inside a double helical elastomer-lined stator 34. During operation, the stator 34 attached to the production tubing 18 remains stationary, and the surface drive 14 coupled to the rotor 32 by the rod string 16 causes the rotor 32 to turn eccentrically in the stator 34. As a result, a series of sealed cavities form between the stator 34 and the rotor 32 and progress from the inlet end to the discharge end of the progressive cavity pump 30, which produces a non-pulsating positive displacement flow.

PCP systems, such as the one shown in FIG. 1, tend to store energy in the rod string 16 and the lifted column of fluid. This stored energy can be problematic if the release of the energy is not controlled properly when the well is shut off or when power from the utility AC power source 12 is lost. For example, the progressive cavity pump 30 is located near the bottom of the wellbore, which may be several thousand feet deep. Therefore, pumping fluid to the surface requires very high pressure. The rod string 16 coupled to the rotor 32 is typically a steel stem having a diameter and a length sufficient for the required operations. During pumping, the rod string 16 may be wound torsionally several dozen times so that the rod string 16 accumulates a substantial amount of stored energy. In addition, the height of the fluid column above the progressive cavity pump 30 can produce hydraulic energy on the rod string 16 while the progressive cavity pump 30 is producing. This hydraulic energy increases the energy of the twisted rod string 16 because it causes the progressive cavity pump 30 to operate as a hydraulic motor, rotating in the same direction as the twisting of the rod string 16. The total sum of all the energy accumulated on the rod string 16 will return to the wellhead 15 when operations are suspended for any reason, either due to normal shut down for maintenance or due to lack of electrical power.

Various mechanical devices have been developed for braking and decelerating surface drive heads to control the release of the stored energy. One mechanical device for dealing with the stored energy uses a downhole dump valve (not shown) to direct fluid out of the production tubing 18 to the annulus. When opened, the dump valve prevents the column of fluid from going through the progressive cavity pump 30 and generating hydraulic energy that causes backspin on the rod string 16. Another downhole device uses a check valve at the pump’s intake. The check valve holds the weight of the fluid column above the progressive cavity pump 30 and keeps it from going through the pump and generating the hydraulic energy that causes backspin on the rod string 16. Although these downhole devices may deal with the problem, these devices can create improper rotor spacing and can reduce the pump's efficiency. Moreover, if these downhole devices fail, then operators must deal with the full stored energy.

Other mechanical devices to control the release of the stored energy are used at the surface. For example, various surface devices can use braking to control the release of stored energy in the rod string 16. The braking can use direct mechanical braking, hydraulic braking, centrifugal braking, or the like at the drive head 24. When pumping is stopped, for example, a braking system is activated to block and/or allow reverse speed control and dissipate the energy accumulated on the rod string 16. Otherwise, the pulleys or gears of the gearbox assembly 22 may become damaged due to the centrifugal force generated by the high rotation that would occur without the braking system.

The electric motor 20 for the PCP system 10 can be an induction motor to operate the progressive cavity pump 30. As is known, an induction motor is a type of AC electric motor that uses alternating current (AC) propelled by a magnetic field that rotates. The induction motor has a stationary stator and a rotational rotor. Electric current in the rotor produces torque, which is obtained by electromagnetic induction from the magnetic field of the stator’s winding.

Instead of an induction motor, the electric motor 20 for the PCP system 10 can be a Permanent Magnet Motor (PMM), which has become more prevalent for use in progressive cavity pump (PCP) systems. As is known, a permanent magnet motor uses permanent magnets for field excitation. The permanent magnet motor offers higher energy efficiency, higher torque, and higher reliability for these systems. The PCP system 10 can use a variable speed drive (VSD) 40 to operate the permanent magnet motor 20 for the progressive cavity pump 30.

For example, FIG. 2 illustrates an example of a variable speed drive (VSD) 40 known in the prior art to operate a permanent magnet motor 20 for a progressive cavity pump 30. The variable speed drive 40 is connected between a utility alternating (AC) power source 12 and a permanent magnet motor 20 for the progressive cavity pump 30. As shown, the three-phase variable speed drive 40 includes a direct current (DC) line or DC bus 41, an input converter 42, a DC bus filter 44, and an output inverter 46.

The input converter 42, which can be an active front-end or a more common pulse diode bridge front-end with a number (e.g., 6, 12, 18, 24) of pulse diodes, is connected to the utility AC power source 12. In this example, the input converter 42 includes a bridge of diodes 43. The input converter 42 converts the three-phase alternating current (AC) power from the utility AC power source 12 to direct DC power for the DC bus 41. The DC bus filter 44, which can be a capacitor bank, smooths the DC power on the DC bus 41. The output inverter 46 then converts the DC power on the DC bus into a variable frequency AC voltage that controls the speed of the permanent magnet motor 20. The output inverter 46 is a three-phase converter having active power devices 47, such as Insulated-Gate Bipolar Transistors (IGBTs), Metal Oxide Silicon Field Effect Transistors (MOSFETs), or wide band-gap devices. These power devices 47 of the output inverter 46 also have anti-parallel diodes to accommodate inductive current flow during the switching instants. Gates signals to these power devices 47 control the speed of the permanent magnet motor 20.

During normal operations, the energy path follows the solid line arrow depicted in FIG. 1. The energy flows from the utility AC power source 12 on the utility side to the permanent magnet motor 20 on the load side of the progressive cavity pump 30.

Although the permanent magnet motor 20 offers several advantages, situations can arise during a power outage of the utility AC power source 12. In particular, when a power outage happens during the operations, the variable speed drive 40 operating the progressive cavity pump 30 will trip, and the falling fluid column in the progressive cavity pump 30 will cause the permanent magnet motor 20 and the progressive cavity pump 30 to rotate in a reverse direction, which is commonly known as “backspin.” This backspin can occur even when mechanical devices are used to mitigate or reduce the backspin. In turn, the back spin makes the permanent magnet motor 20 operate as a generator, creating regenerative energy.

As depicted by the dashed line arrow, this regenerative energy flows back to the DC bus 41 of the variable speed drive 40 using the reverse diodes of the output inverter 46. The regenerative energy can cause the DC voltage of the DC bus 41 to rise even when the utility voltage is not present. The DC voltage can become high enough to be a safety hazard even during the power outage. This unmanaged voltage rise can also potentially damage the variable speed drive 40.

The subject matter of the present disclosure is directed to overcoming, or at least reducing the effects of, one or more of the problems set forth above.

### SUMMARY OF THE DISCLOSURE

A variable speed drive disclosed herein is for use with an alternating current (AC) power source and a permanent magnet motor of a load device. The variable speed drive comprises an input converter, an output inverter, a detector, a contactor, and a resistor. The input converter is configured to convert input AC power from the AC power source to direct current (DC) power on first and second lines of a DC bus, and the output inverter is connected to the DC bus and is configured to convert the DC power to output AC power for the permanent magnet motor. The detector is responsive to the input AC power from with the AC power source. The contactor, which is associated with the detector, is connected in series with a resistor between the first and second lines of the DC bus. The contactor has a disconnected state in response to the presence of the input AC power, and the contactor in the disconnected state electrically disconnects the resistor between the first and second lines of the DC bus. The contactor has a connected state in response to an absence of the input AC power, and the contactor in the connected state electrically connects the resistor between the first and second lines of the DC bus.

The input converter can comprise an active front-end or a pulse diode bridge front-end configured to convert three-phase AC of the input AC power from the AC power source to the DC power for the DC bus. The output inverter can comprise active power devices having anti-parallel diodes to accommodate inductive current flow during switching instants, wherein the output inverter is configured to convert the DC power on the DC bus into three-phase AC of variable frequency for the output AC power that controls the speed of the permanent magnet motor. The active power devices can comprise Insulated-Gate Bipolar Transistors (IGBTs), Metal Oxide Silicon Field Effect Transistors (MOSFETs), or wide band-gap devices.

The variable speed drive can comprise a filter connected between the first and second lines of the DC bus and being configured to filter the DC power of the DC bus.

The contactor can be connected to the first line of the DC bus, and the resistor can be connected between the contactor and the second line of the DC bus.

The variable speed drive can further comprise a chopper circuit, a diode, and a dynamic braking resistor. The chopper circuit and the diode can be connected in series between the first and second lines of the DC bus. The dynamic braking resistor can have a first connection to the first line of the DC bus and can have a second connection between the chopper circuit and the diode.

In one configuration, the contactor can be connected to the first line of the DC bus. The resistor can be a dynamic braking resistor having a chopper circuit. The dynamic braking resistor can have a first connection to the contactor and can have a second connection to the second line of the DC bus. The chopper circuit can be connected between the first line of the DC bus and the first connection of the dynamic braking resistor. A diode can be connected in parallel across the chopper circuit.

In another configuration, the detector can comprise a circuit being energized in an energized state in the presence of the input AC power and being de-energized in a de-energized state in the absence of the input AC power. The contactor can have the disconnected state in response to the circuit in the energized state. The contactor can have the connected state in response to the circuit in the de-energized state. For example, the contactor can comprise a normally closed contactor being electrically held open by an electromagnetic coil of the detector.

The detector can comprise a circuit that is de-energized in a de-energized state in the presence of the input AC power and that is energized at least momentarily in an energized state when the input AC power is lost (i.e., in response to a change from the presence to the absence of the input AC power). The contactor can have the disconnected state in response to the circuit in the de-energized state, and the contactor can switch from the disconnected state to the connected state in response to the circuit in the energized state.

The contactor can comprise a mechanically held contactor having contacts being held in place mechanically without continuous electrical power. A circuit of the detector can de-energize a coil of the contactor in the presence of the input AC power to keep the contacts open. The circuit of the detector can energize the coil of the contactor at least momentarily in response to a change from the presence to the absence of the input AC power to cause the contacts to close.

A progressive cavity pump unit is used with an alternating current (AC) power source. The progressive cavity pump unit comprises a permanent magnet motor; and a variable speed drive having any of the above features.

A method is used with a variable speed drive, which is connected to an alternating (AC) power source and configured to drive a permanent magnet motor. The method comprises: driving the permanent magnet motor in a presence of input AC power from the AC power source by: converting, in an input converter, the input AC power from the AC power source to DC power for a DC bus of the variable speed drive; and converting, in an output inverter, the DC power on the DC bus drawn from the input converter to output AC power for the permanent magnet motor.

The method comprises detecting a power outage associated with the input AC power from the AC power source. The method comprises dissipating any regenerative energy on the DC bus from the permanent magnet motor in response to the power outage by: changing a contactor from a disconnected state to a connected state; and electrically connecting a resistor in series with the contactor in the connected state across first and second lines of the DC bus.

To drive the permanent magnet motor, the contactor can be maintained in the disconnected state. To drive the permanent magnet motor, the DC power of the DC bus can be filtered with a filter connected across the first and second lines of the DC bus.

To drive the permanent magnet motor, any regenerative energy on the DC bus from the permanent magnet motor in the presence of the input AC power from the AC power source can be dissipated by cycling the regenerative energy through the resistor with a chopper circuit.

To detect the power outage associated with the input AC power from the AC power source, a circuit can be energized in an energized state in the presence of the input AC power, and the circuit can be de-energized in a de-energized state in an absence of the input AC power. Changing the contactor from the disconnected state to the connected state can comprise placing the contactor in the disconnected state in response to the circuit in the energized state, and placing the contactor in the connected state in response to the circuit in the de-energized state.

To energize and de-energize the circuit, an electromagnetic coil can be energized and de-energized. Placing the contactor in the disconnected state and the connected state can comprise holding a normally closed contactor electrically open in the disconnected state with the electromagnetic coil in the energized state, and permitting the normally closed contactor to close in the connected state with the electromagnetic coil in the de-energized state.

To detect the power outage associated with the input AC power from the AC power source, a circuit can be de-energized in an de-energized state in the presence of the input AC power, and the circuit can be energized at least momentarily in an energized state in response to a change from the presence of the input AC power to the power outage. Changing the contactor from the disconnected state to the connected state can comprise placing the contactor in the disconnected state in response to the circuit in the de-energized state, and switching the contactor from the disconnected state to the connected state in response to the circuit in the energized state.

To energize and de-energize the circuit, an electromagnetic coil can be energized and de-energized. Placing the contactor in the disconnected state and the connected state can comprise holding a mechanically held contactor having contacts being held in place mechanically without continuous electrical power, and switching the mechanically held contactor from the disconnected state to the connected state in response the electromagnetic coil at least momentarily energized in the energized state.

The foregoing summary is not intended to summarize each potential embodiment or every aspect of the present disclosure.

### BRIEF DESCRIPTION OF DRAWINGS

FIG. 1 illustrates a Progressive Cavity Pump (PCP) system according to the state of the art.

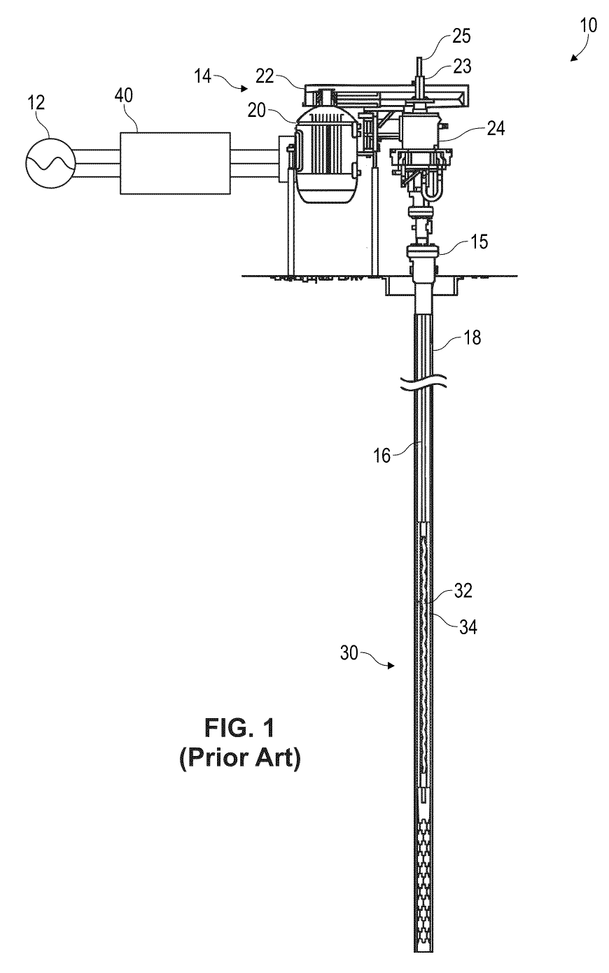

FIG. 2 illustrates a variable speed drive according to the state of the art for operating a permanent magnet motor of a progressive cavity pump system.

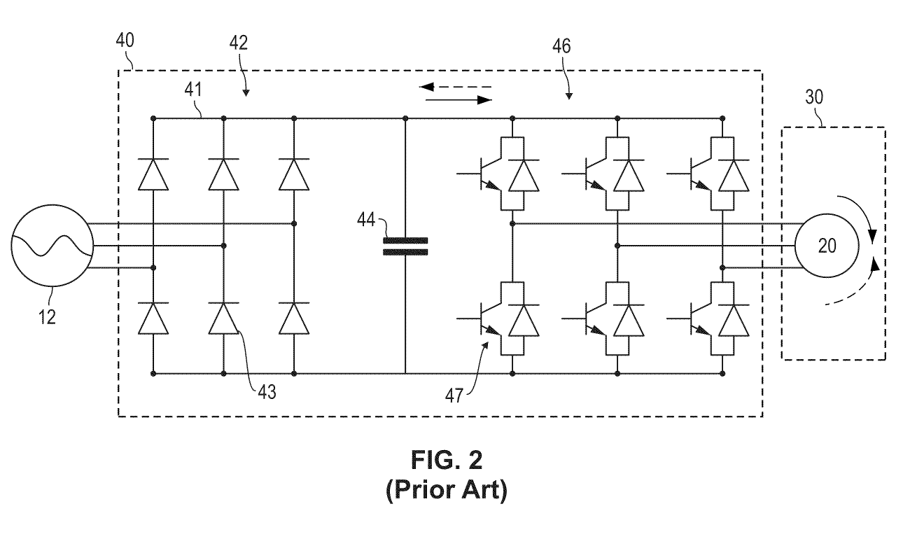

FIG. 3 illustrates a variable speed drive according to the present disclosure for operating a permanent magnet motor of a progressive cavity pump system.

FIG. 4 illustrates another variable speed drive according to the present disclosure for operating a permanent magnet motor of a progressive cavity pump system.

FIG. 5 illustrates another variable speed drive according to the present disclosure for operating a permanent magnet motor of a progressive cavity pump system.

### DETAILED DESCRIPTION OF THE DISCLOSURE

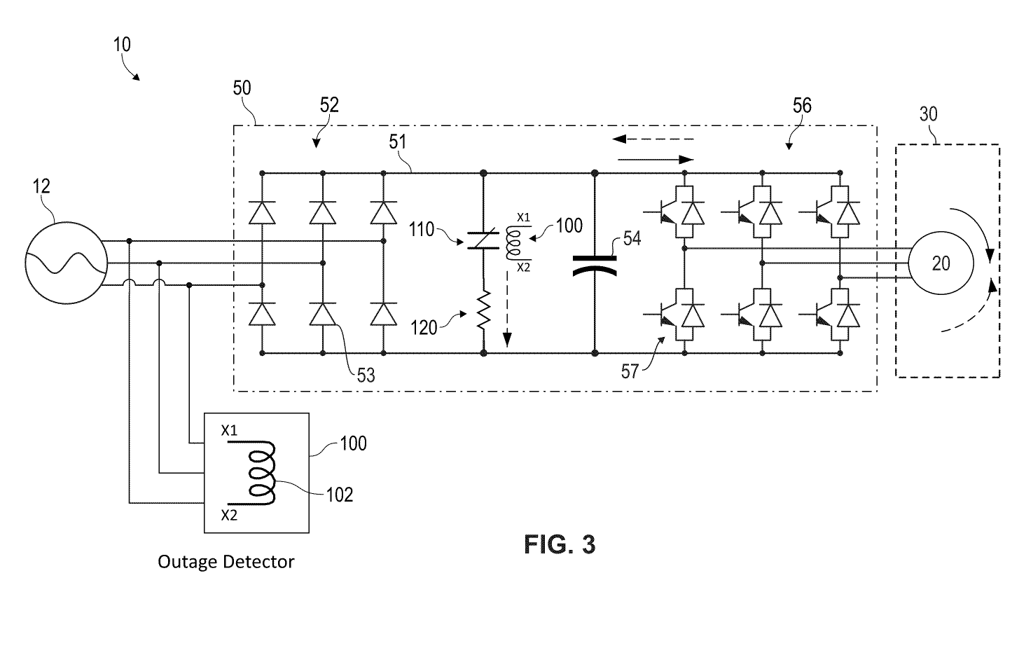

FIG. 3 illustrates a variable speed drive 50 according to the present disclosure for operating a permanent magnet motor 20 of a progressive cavity pump system 10. The variable speed drive 50 is configured to mitigate a rise in DC voltage from backspin of the permanent magnet motor 20 during a power outage. The variable speed drive 50 is connected between a utility alternating (AC) power source 12 and the permanent magnet motor 20 for a load, such as a progressive cavity pump 30. As shown, the three-phase variable speed drive 50 includes a direct current (DC) line or DC bus 51, an input converter 52, a DC bus filter 54, and an output inverter 56.

The input converter 52 can be an active front-end or can be a more common pulse diode bridge front-end connected to the utility AC power source 12. In this example, the input converter 52 includes a bridge of diodes 53. As an active front-end, the input converter 52 can use controlled semiconductor devices (e.g., Insulated-Gate Bipolar Transistors (IGBTs), Metal Oxide Silicon Field Effect Transistors (MOSFETs)) instead of passive diodes. Either way, the input converter 52 converts the three-phase alternating current (AC) power from the utility AC power source 12 to direct DC power for the DC bus 51. The DC bus filter 54, which can be a capacitor bank, smooths the DC power on the DC bus 51. The output inverter 56 then converts the DC power on the DC bus 51 into a variable frequency AC voltage that controls the speed of the permanent magnet motor 20.

The output inverter 56 is a three-phase converter having active power devices 57, such as Insulated-Gate Bipolar Transistors (IGBTs), Metal Oxide Silicon Field Effect Transistors (MOSFETs), or wide band-gap devices. These power devices 57 of the output inverter 56 also have anti-parallel diodes to accommodate inductive current flow during the switching instants. Gates signals to these power devices 57 control the speed of the permanent magnet motor 20.

During normal operations, the energy path follows the solid line arrow depicted in FIG. 3. The energy flows from the utility AC power source 12 on the utility side to the permanent magnet motor 20 on the load side of the progressive cavity pump 30.

Although the permanent magnet motor 20 offers several advantages, situations can arise during a power outage (i.e., absence of the input AC power) of the utility AC power source 12. In particular, when a power outage happens during the operations, the variable speed drive 50 operating the progressive cavity pump 30 will trip, and the falling fluid column in the progressive cavity pump 30 will cause the permanent magnet motor 20 and the progressive cavity pump 30 to rotate in a reverse direction, which is commonly known as “backspin.” This backspin makes the permanent magnet motor 20 operate as a generator, creating regenerative energy.

As depicted by the dashed line arrow, this regenerative energy flows back to the DC bus 51 of the variable speed drive 50 using the reverse diodes of the output inverter 56. The regenerative energy can cause the DC voltage of the DC bus 51 to rise even when the utility voltage is not present. The DC voltage can become high enough to be a safety hazard even during the power outage. This unmanaged voltage rise can also potentially damage the variable speed drive 50.

To mitigate an increase in DC voltage during the power outage, the variable speed drive 50 detects the power outage using an outage detector 100 to close a contactor 110. When the power outage is detected, the variable speed drive 500 closes the contactor 110 to bring a resistor 120 in series with the drive’s DC bus 51 so the energy on the DC bus 51 can be depleted as heat. As a result, a rise in the DC voltage of the DC bus 51 due to back spin can be mitigated.

The contactor 110 can be designed to be electrically held in either a normally open (NO) or normally closed (NC) state. The outage detector 100 can control the contactor 110 for the contacts to be open during normal operation to prevent current flow through the resistor 120. In turn, the outage detector 100 can control the contactor 110 for the contacts to be closed in a closed (connected) state during power outage to allow current flow through the resistor 120.

In one example, the contactor 110 can be a normally closed contactor that is electrically held open. The outage detector 100 can use a circuit that is energized in an energized state by the presence of the input AC power from the utility AC power source 12. As long as the outage detector 100 is energized, it maintains the contactor 110 in an open (disconnected) state. The outage detector 100 can use a solenoid or electromagnet that is energized to hold the contacts of the contactor 110 open. For its part, the contactor 110 can be spring-loaded and biased to close but can be held open by the electromagnetism produced by the outage detector 100 as long as the outage detector 100 remains energized. Once a power outage occurs, the outage detector 100 is no longer energized in the absence of the input AC power of the utility AC power source 12, and the contactor 110 is no longer held in an open (disconnected) state. As a result of the detector 100 in a de-energized state, the contactor 110 closes to a closed (connected) state to connect the resistor 120 across the conductors of the DC bus 51.

For this arrangement, the outage detector 100 and the contactor 110 can use a normally closed contactor having a coil or solenoid mechanism to hold the contactor open in an open (disconnected) state. The contactor 110 can be spring-loaded having a default state (no power) in which the contacts are closed. Power supplied to the coil for the outage detector 100 can hold the contacts physically apart using a magnetic field. When power is lost, the loss of power de-energizes the coil, and the spring loading pushes the contactor 110 closed, allowing the contacts to return to their default closed position and thereby enabling current flow through the resistor 120. In an alternative, the outage detector 100 and the contactor 110 can use a latching relay or a mechanically held contactor with NO (normally open) and NC (normally closed) logic. An auxiliary control relay can use power to break the circuit via normally closed contacts. During power failure, the auxiliary relay releases, closing the power circuit.

In another example, the contactor 110 can be a mechanically held contactor. The mechanically held contactor 110 does not inherently change its state due to a power outage. Instead, the mechanically held contactor 110 requires only a momentary current to change its state (either opening or closing the contacts). Once the contacts are in a particular position, the contacts are mechanically held in place without the need for continuous electrical power. During normal power conditions, the outage detector 100 can use a control circuit that de-energizes a coil of the contactor 110 in a de-energized state, keeping the contacts in an open state even in the presence of the input AC power. During a power loss, the outage detector 100 then energizes the contactor’s coil momentarily in an energized state, causing the contacts to close. The mechanically held contactor 110 can then maintain its position during the power loss. Accordingly, the control circuitry of the outage detector 100 is configured to detect the power loss and send an appropriate signal to the contactor 110 to change its state.

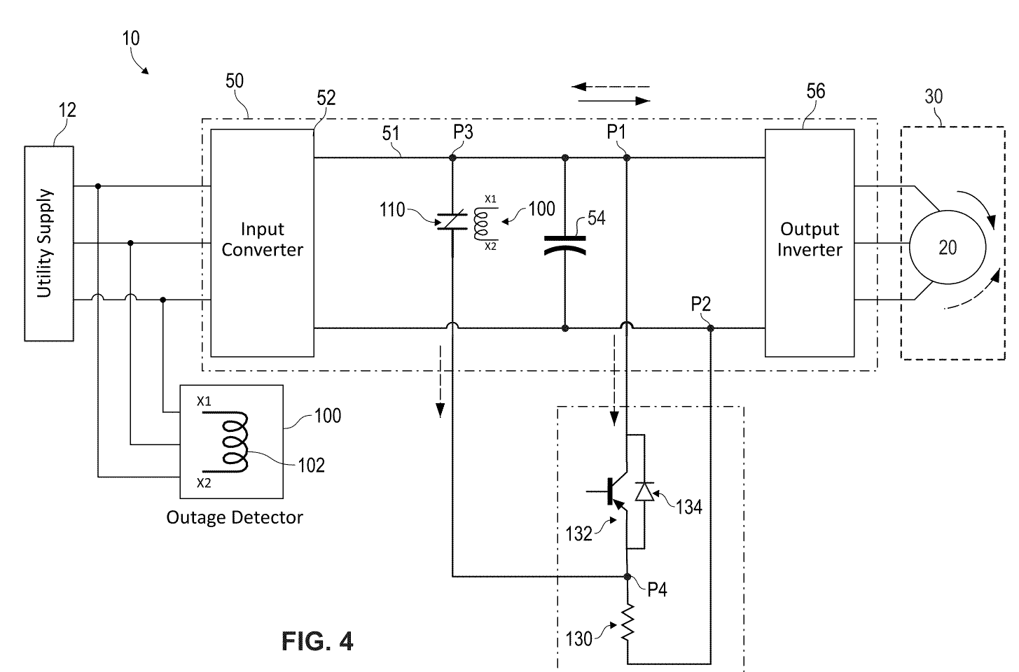

FIG. 4 illustrates another variable speed drive 50 according to the present disclosure for operating a permanent magnet motor 20 of a progressive cavity pump system 10. Again, the variable speed drive 50 is configured to mitigate a rise in DC voltage from backspin of the permanent magnet motor 20 during a power outage (i.e., absence of the input AC power). The variable speed drive 50 is similar to that disclosed above so that the same reference numerals are used for comparable components. As such, the variable speed drive 50 includes a DC bus 51, an input converter 52, a DC filter 54, and an output inverter 56.

The variable speed drive 50 also includes a dynamic braking resistor (DBR) 130 and a chopper circuit having a brake chopper transistor 132 with a diode 134. The variable speed drive 50 can mitigate the rise in DC voltage by using the dynamic braking resistor 130 integrated into the variable speed drive 50.

As shown, the dynamic braking resistor 130 and the brake chopper transistor 132 are connected across the DC bus 51 at connection points P1, P2. During normal operation, overhauling or decelerating loads on the permanent magnet motor 20 can make the permanent magnet motor 20 turn faster than the synchronous speed set by the variable speed drive 50. When this happens, the permanent magnet motor 20 acts as a generator, in which mechanical energy from the permanent magnet motor 20 is converted into regenerative energy, which flows back into the variable speed drive 50 and increases the voltage of the DC bus 51.

Receiving gate signals, the brake chopper transistor 132 can turn the dynamic braking resistor 130 continuously on and off in a duty cycle until any regenerative energy is dissipated as heat. When the voltage of the DC bus 51 exceeds a defined threshold, for example, the brake chopper transistor 132 closes or is “shunted” so current will flow across the dynamic brake resistor 130 where the electrical energy is converted to heat.

As further shown in FIG. 4, the contactor 110 can connect in series with the dynamic braking resistor 130 across the DC bus 51 at connection points P3, P4, P2. During a power outage, the brake chopper transistor 132 does not receive gate signals. Instead, the outage detector 100 connected to the utility AC power source 12 detects the power outage and closes the contactor 110 so that the dynamic braking resistor 130 is connected across the DC bus 51. The dynamic braking resistor 130 can then dissipate the regenerative energy as heat. The brake chopper transistor 132 can be bypassed during the power outage.

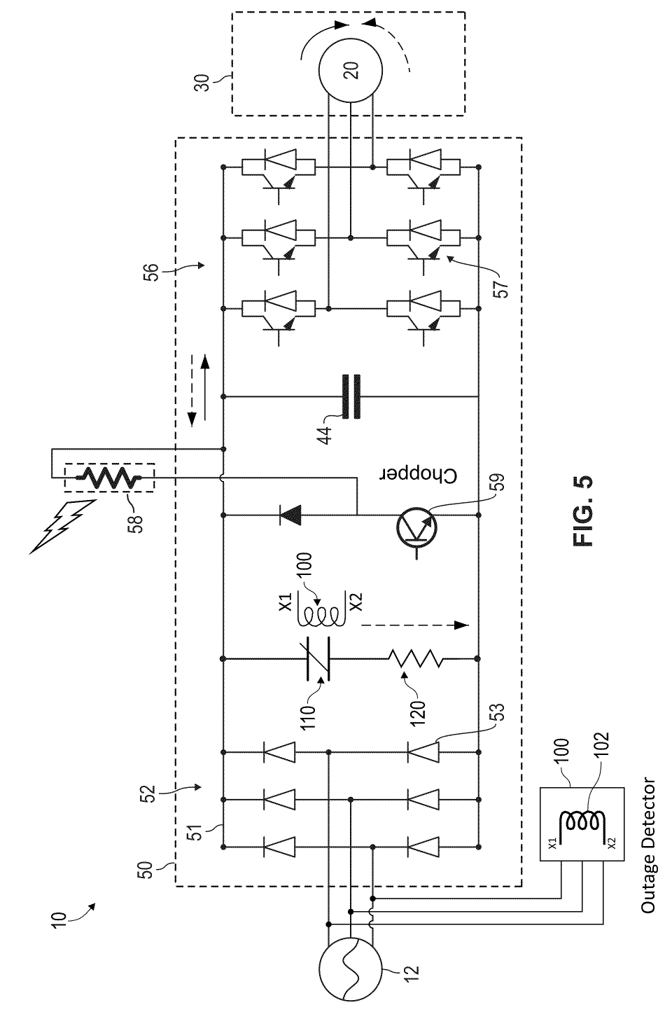

FIG. 5 illustrates another variable speed drive 50 according to the present disclosure for operating a permanent magnet motor 20 of a progressive cavity pump system 10. The variable speed drive 50 is similar to that disclosed above so that the same reference numerals are used for comparable components. As such, the variable speed drive 50 includes a DC bus 51, an input converter 52, a DC filter 54, and an output inverter 56. The variable speed drive 50 also includes a dynamic braking resistor (DBR) 58 and a chopper circuit 59 with a diode, which is integrated into the variable speed drive 50. Similar to the arrangement in FIG. 3, an outage detector 100, a contactor 110, and a resistor 120 are integrated into the variable speed drive 50. Unlike the arrangement in FIG. 4, however, the dynamic braking resistor 58 in this configuration is separate from the contactor 110 and the associated resistor 120.

Configurations of the present disclosure can be characterized as follows:
1. A variable speed drive (50) for use with an alternating current (AC) power source (12) and a permanent magnet motor (20) of a load device, the variable speed drive (50) comprising:
   an input converter (52) being configured to convert input AC power from the AC power source (12) to direct current (DC) power on first and second lines of a DC bus (51);
   an output inverter (56) connected to the DC bus (51) and being configured to convert the DC power to output AC power for the permanent magnet motor (20);
   a detector (100) being responsive to the input AC power from with the AC power source (12); and
   a contactor (110) being associated with the detector (100), the contactor (110) connected in series with a resistor (120, 130) between the first and second lines of the DC bus (51), the contactor (110) having a disconnected state in response to a presence of the input AC power, the contactor (110) in the disconnected state electrically disconnecting the resistor (120, 130) between the first and second lines of the DC bus (51), the contactor (110) having a connected state in response to an absence of the input AC power, the contactor (110) in the connected state electrically connecting the resistor (120, 130) between the first and second lines of the DC bus (51).
2. The variable speed drive (50) of Clause 1, wherein the input converter (52) comprises an active front-end or a pulse diode bridge front-end configured to convert three-phase AC of the input AC power from the AC power source (12) to the DC power for the DC bus (51).
3. The variable speed drive (50) of Clause 1 or 2, wherein the output inverter (56) comprises active power devices (57) having anti-parallel diodes to accommodate inductive current flow during switching instants, wherein the output inverter (56) is configured to convert the DC power on the DC bus (51) into three-phase AC of variable frequency for the output AC power that controls a speed of the permanent magnet motor (20).
4. The variable speed drive (50) of Clause 1, 2 or 3, comprising a filter (54) connected between the first and second lines of the DC bus (51) and being configured to filter the DC power of the DC bus (51).
5. The variable speed drive (50) of any one of Clauses 1 to 4, wherein the contactor (110) is connected to the first line of the DC bus (51); and wherein the resistor (120, 130) is connected between the contactor (110) and the second line of the DC bus (51).
6. The variable speed drive (50) of any one of Clauses 1 to 5, further comprising:
   a chopper circuit (59) and a diode connected in series between the first and second lines of the DC bus (51); and
   a dynamic braking resistor (58) having a first connection to the first line of the DC bus (51) and having a second connection between the chopper circuit and the diode.
7. The variable speed drive (50) of any one of Clauses 1 to 5, wherein the contactor (110) is connected to the first line of the DC bus (51); and wherein the resistor (130) is a dynamic braking resistor having a chopper circuit (132), the dynamic braking resistor (130) having a first connection to the contactor (110) and having a second connection to the second line of the DC bus (51), the chopper circuit (132) connected between the first line of the DC bus (51) and the first connection of the dynamic braking resistor (130).
8. The variable speed drive (50) of any one of Clauses 1 to 7, wherein the detector (100) comprises a circuit (102) being energized in an energized state in the presence of the input AC power and being de-energized in an de-energized state in the absence of the input AC power, the contactor (110) having the disconnected state in response to the circuit (102) in the energized state, the contactor (110) having the connected state in response to the circuit in the de-energized state.
9. The variable speed drive (50) of any one of Clauses 1 to 8, wherein the contactor (110) comprises a normally closed contactor (110) being electrically held open by an electromagnetic coil (102) of the detector (100).
10. The variable speed drive (50) of any one of Clauses 1 to 7, wherein the detector (100) comprises a circuit (102) being de-energized in an de-energized state in the presence of the input AC power and being energized at least momentarily in an energized state in response to a change from the presence to the absence of the input AC power, the contactor (110) having the disconnected state in response to the circuit (102) in the de-energized state, the contactor (110) switching from the disconnected state to the connected state in response to the circuit (102) in the energized state.
11. The variable speed drive (50) of any one of Clauses 1 to 7, wherein the contactor (110) comprises a mechanically held contactor (110) having contacts being held in place mechanically without continuous electrical power, a circuit (102) of the detector (100) de-energizing a coil of the contactor (110) in the presence of the input AC power to keep the contacts open, the circuit of the detector (100) energizing the coil of the contactor (110) at least momentarily in response to a change from the presence to the absence of the input AC power to cause the contacts to close.
12. A progressive cavity pump unit used with an alternating current (AC) power source (12), the progressive cavity pump unit comprising:
   a permanent magnet motor (20); and
   a variable speed drive (50) according to any one of Clauses 1 to 11.
13. A method used with a variable speed drive (50), the variable speed drive (50) connected to an alternating (AC) power source (12) and configured to drive (50) a permanent magnet motor (20), the method comprising:
   driving the permanent magnet motor (20) in a presence of input AC power from the AC power source (12) by: converting, in an input converter (52), the input AC power from the AC power source (12) to DC power for a DC bus (51) of the variable speed drive (50); and converting, in an output inverter (56), the DC power on the DC bus (51) drawn from the input converter (52) to output AC power for the permanent magnet motor (20);
   detecting a power outage associated with the input AC power from the AC power source (12); and
   dissipating any regenerative energy on the DC bus (51) from the permanent magnet motor (20) in response to the power outage by: changing a contactor (110) from a disconnected state to a connected state; and electrically connecting a resistor in series with the contactor (110) in the connected state across first and second lines of the DC bus (51).
14. The method of Clause 13, wherein detecting the power outage associated with the input AC power from the AC power source (12) comprises energizing a circuit in an energized state in the presence of the input AC power, and de-energizing the circuit in an de-energized state in an absence of the input AC power; and wherein changing the contactor (110) from the disconnected state to the connected state comprises placing the contactor (110) in the disconnected state in response to the circuit in the energized state, and placing the contactor (110) in the connected state in response to the circuit in the de-energized state.
15. The method of Clause 13, wherein detecting the power outage associated with the input AC power from the AC power source (12) comprises de-energizing a circuit in an de-energized state in the presence of the input AC power, and energizing the circuit at least momentarily in an energized state in response to a change from the presence of the input AC power to the power outage; and wherein changing the contactor (110) from the disconnected state to the connected state comprises placing the contactor (110) in the disconnected state in response to the circuit in the de-energized state, and switching the contactor (110) from the disconnected state to the connected state in response to the circuit in the energized state.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

1. A variable speed drive for use with an alternating current (AC) power source and a permanent magnet motor of a load device, the variable speed drive comprising:
an input converter being configured to convert input AC power from the AC power source to direct current (DC) power on first and second lines of a DC bus;
an output inverter connected to the DC bus and being configured to convert the DC power to output AC power for the permanent magnet motor;
a detector being responsive to the input AC power from with the AC power source; and
a contactor being associated with the detector, the contactor connected in series with a resistor between the first and second lines of the DC bus, the contactor having a disconnected state in response to a presence of the input AC power, the contactor in the disconnected state electrically disconnecting the resistor between the first and second lines of the DC bus, the contactor having a connected state in response to an absence of the input AC power, the contactor in the connected state electrically connecting the resistor between the first and second lines of the DC bus.

2. The variable speed drive of claim 1, wherein the input converter comprises an active front-end or a pulse diode bridge front-end configured to convert three-phase AC of the input AC power from the AC power source to the DC power for the DC bus.

3. The variable speed drive of claim 1, wherein the output inverter comprises active power devices having anti-parallel diodes to accommodate inductive current flow during switching instants, wherein the output inverter is configured to convert the DC power on the DC bus into three-phase AC of variable frequency for the output AC power that controls a speed of the permanent magnet motor.

4. The variable speed drive of claim 3, wherein the active power devices comprise Insulated-Gate Bipolar Transistors (IGBTs), Metal Oxide Silicon Field Effect Transistors (MOSFETs), or wide band-gap devices.

5. The variable speed drive of claim 1, comprising a filter connected between the first and second lines of the DC bus and being configured to filter the DC power of the DC bus.

6. The variable speed drive of claim 1, wherein the contactor is connected to the first line of the DC bus; and wherein the resistor is connected between the contactor and the second line of the DC bus.

7. The variable speed drive of claim 1, further comprising:
a chopper circuit and a diode connected in series between the first and second lines of the DC bus; and
a dynamic braking resistor having a first connection to the first line of the DC bus and having a second connection between the chopper circuit and the diode.

8. The variable speed drive of claim 1, wherein the contactor is connected to the first line of the DC bus; and wherein the resistor is a dynamic braking resistor having a chopper circuit, the dynamic braking resistor having a first connection to the contactor and having a second connection to the second line of the DC bus, the chopper circuit connected between the first line of the DC bus and the first connection of the dynamic braking resistor.

9. The variable speed drive of claim 8, further comprising a diode connected in parallel across the chopper circuit.

10. The variable speed drive of claim 1, wherein the detector comprises a circuit being energized in an energized state in the presence of the input AC power and being de-energized in an de-energized state in the absence of the input AC power, the contactor having the disconnected state in response to the circuit in the energized state, the contactor having the connected state in response to the circuit in the de-energized state.

11. The variable speed drive of claim 1, wherein the contactor comprises a normally closed contactor being electrically held open by an electromagnetic coil of the detector.

12. The variable speed drive of claim 1, wherein the detector comprises a circuit being de-energized in an de-energized state in the presence of the input AC power and being energized at least momentarily in an energized state in response to a change from the presence to the absence of the input AC power, the contactor having the disconnected state in response to the circuit in the de-energized state, the contactor switching from the disconnected state to the connected state in response to the circuit in the energized state.

13. The variable speed drive of claim 1, wherein the contactor comprises a mechanically held contactor having contacts being held in place mechanically without continuous electrical power, a circuit of the detector de-energizing a coil of the contactor in the presence of the input AC power to keep the contacts open, the circuit of the detector energizing the coil of the contactor at least momentarily in response to a change from the presence to the absence of the input AC power to cause the contacts to close.

14. A progressive cavity pump unit used with an alternating current (AC) power source, the progressive cavity pump unit comprising:
a permanent magnet motor; and
a variable speed drive according to claim 1.

15. A method used with a variable speed drive, the variable speed drive connected to an alternating (AC) power source and configured to drive a permanent magnet motor, the method comprising:
driving the permanent magnet motor in a presence of input AC power from the AC power source by:
converting, in an input converter, the input AC power from the AC power source to DC power for a DC bus of the variable speed drive; and
converting, in an output inverter, the DC power on the DC bus drawn from the input converter to output AC power for the permanent magnet motor;
detecting a power outage associated with the input AC power from the AC power source; and
dissipating any regenerative energy on the DC bus from the permanent magnet motor in response to the power outage by:
changing a contactor from a disconnected state to a connected state; and
electrically connecting a resistor in series with the contactor in the connected state across first and second lines of the DC bus.

16. The method of claim 15, wherein driving the permanent magnet motor comprises maintaining the contactor in the disconnected state.

17. The method of claim 15, wherein driving the permanent magnet motor comprises filtering the DC power of the DC bus with a filter connected across the first and second lines of the DC bus.

18. The method of claim 15, wherein driving the permanent magnet motor comprises dissipating any regenerative energy on the DC bus from the permanent magnet motor in the presence of the input AC power from the AC power source by cycling the regenerative energy through the resistor with a chopper circuit.

19. The method of claim 15, wherein detecting the power outage associated with the input AC power from the AC power source comprises energizing a circuit in an energized state in the presence of the input AC power, and de-energizing the circuit in an de-energized state in an absence of the input AC power; and wherein changing the contactor from the disconnected state to the connected state comprises placing the contactor in the disconnected state in response to the circuit in the energized state, and placing the contactor in the connected state in response to the circuit in the de-energized state.

20. The method of claim 19, wherein energizing and de-energizing the circuit comprises energizing and de-energizing an electromagnetic coil; and wherein placing the contactor in the disconnected state and the connected state comprises holding a normally closed contactor electrically open in the disconnected state with the electromagnetic coil in the energized state, and permitting the normally closed contactor to close in the connected state with the electromagnetic coil in the de-energized state.

21. The method of claim 15, wherein detecting the power outage associated with the input AC power from the AC power source comprises de-energizing a circuit in an de-energized state in the presence of the input AC power, and energizing the circuit at least momentarily in an energized state in response to a change from the presence of the input AC power to the power outage; and wherein changing the contactor from the disconnected state to the connected state comprises placing the contactor in the disconnected state in response to the circuit in the de-energized state, and switching the contactor from the disconnected state to the connected state in response to the circuit in the energized state.

22. The method of claim 21, wherein energizing and de-energizing the circuit comprises energizing and de-energizing an electromagnetic coil; and wherein placing the contactor in the disconnected state and the connected state comprises holding a mechanically held contactor having contacts being held in place mechanically without continuous electrical power, and switching the mechanically held contactor from the disconnected state to the connected state in response the electromagnetic coil at least momentarily energized in the energized state.
